(19) United States
(12) Patent Application Publication
(10) Pub. No.: US 2024/0185268 A1
(43) Pub. Date: Jun. 6, 2024

(54) System and Method for Calculating Flare Volumes

(71) Applicant: Devon Energy Corporation, Oklahoma City, OK (US)

(72) Inventor: Jeremy Candrian, Kildeer, ND (US)

(73) Assignee: Devon Energy Corporation, Oklahoma City, OK (US)

(21) Appl. No.: 18/527,272

(22) Filed: Dec. 2, 2023

Related U.S. Application Data
(60) Provisional application No. 63/429,816, filed on Dec. 2, 2022.

(51) Int. Cl. G06Q 30/0201; E21B 41/00

(52) U.S. Cl. CPC G06Q 30/0201; E21B 41/0071

(57) ABSTRACT

A computer-implemented method for calculating an estimated flare volume of natural gas produced from a well is determined as function of reduced volumes sent to a sales line or gathering system. The method includes the steps of determining a baseline static pressure for the gathering system with a static pressure gauge, determining a baseline gas sales rate with a gas sales line flowmeter, identifying a high static pressure event with the static pressure gauge, determining a lost gas sales volume during the high static pressure event, and determining the estimated flare volume as a function of the lost gas sales volume during the high static pressure event.

### RELATED APPLICATIONS

The present application claims the benefit of U.S. Provisional Patent Application Ser. No. 63/429,816 filed Dec. 2, 2023 entitled “System and Method for Calculating Flare Volumes,” the disclosure of which is herein incorporated by reference.

### FIELD OF THE INVENTION

This invention relates generally to the field of oil and gas production and more particularly, but not by way of limitation, to an improved method for calculating the volume of natural gas flared at a wellsite.

### BACKGROUND

The production of petroleum products from subterranean reservoirs often involves bringing mixtures of gases and liquids to the surface. The ratio of gas to oil in a given well or field is often referred to as the gas-to-oil ratio, or GOR. Depending on commodity prices, the demand for liquid crude oil may outpace the demand for natural gas, which is sometimes referred to by its primary component, methane. For many years, the oil industry viewed natural gas as an undesirable byproduct of the production of crude oil and vented or flared the natural gas directly to the atmosphere.

More recently, there has been an increased regulatory emphasis on limiting the volume of natural gas sent to flares. Natural gas has been identified as a potent greenhouse gas and the byproducts of its combustion through flaring—including carbon dioxide—are also known to contribute to greenhouse gas emissions. Producers of petroleum products are therefore required to monitor and measure the emission of natural gas and its combustion byproducts under modern regulatory programs.

In the past, the determination of the volume of gas sent to a flare was typically made by: (i) determining the applicable gas-to-oil ratio (GOR); (ii) measuring the volume of crude produced from a typical well; and then (iii) calculating the estimated total volume of produced natural gas as a function of the gas-to-oil ratio. The volume of natural gas sent to a flare could be estimated by taking the total volume of natural gas from the GOR calculation and then subtracting the sum of the volume of gas transferred to downstream processing facilities on a sales line and the volume of gas used for beneficial purposes at the wellsite. Although widely adopted, the GOR-based calculations are indirect and require several inputs before an estimation of flare gas volumes can be made. There is, therefore, a need for an improved system and method for estimating the volume of natural gas sent to a flare. The present disclosure is directed to these and other deficiencies in the prior art.

### SUMMARY OF THE INVENTION

In some embodiments, the present disclosure is directed to a computer-implemented method for calculating an estimated flare volume of natural gas produced from a well connected to a gathering system through a gas sales line. The method includes the steps of determining a baseline static pressure for the gathering system with a static pressure gauge, reporting the static pressure to a computerized control system, determining a baseline gas sales rate with a gas sales line flowmeter, reporting the baseline gas sales rate to the computerized control system, identifying a high static pressure event with the static pressure gauge, reporting the high static pressure event to the computerized control system, identifying a decline in the gas sales rate that correlates to the onset of the high static pressure event, reporting the decline in the gas sales rate to the computerized control system, identifying the conclusion of the high static pressure event with the static pressure gauge, reporting the conclusion of the high static pressure event to the computerized control system, determining the lost gas sales volume as a function of the difference between the actual gas sales rate and the baseline gas sales rate beginning with the onset of the high static pressure event, and determining the estimated flare volume as the lost gas sales volume.

In other embodiments, the present disclosure is directed to a computer-implemented method for calculating an estimated flare volume of natural gas produced from a well connected to a gathering system through a gas sales line. In these embodiments, the method includes the steps of determining a baseline static pressure for the gathering system with a static pressure gauge, determining a baseline gas sales rate with a gas sales line flowmeter, identifying a high static pressure event with the static pressure gauge, determining a lost gas sales volume during the high static pressure event, and determining the estimated flare volume as a function of the lost gas sales volume.

In yet other embodiments, the present disclosure is directed at a method for calculating an estimated flare volume of natural gas produced from a well connected to a gathering system through a gas sales line, where the method includes the steps of determining a baseline static pressure for the gathering system with a static pressure gauge, determining a baseline gas sales rate with a gas sales line flowmeter, identifying an onset of a high static pressure event with the static pressure gauge, automatically diverting natural gas to a flare, identifying a conclusion of the high static pressure event with the static pressure gauge, automatically diverting natural gas from the flare to the gas sales line, determining a lost gas sales volume during the high static pressure event, and determining the estimated flare volume as a function of the lost gas sales volume.

### BRIEF DESCRIPTION OF THE DRAWINGS

FIG. 1 is a depiction of a typical wellsite incorporating a system for determining the volume of natural gas sent to a flare.

FIG. 2 is a graph that depicts the measurements made to estimate the volume of flared gas based on changes to static pressure and changes to the volume of gas directed to the sales line.

### WRITTEN DESCRIPTION

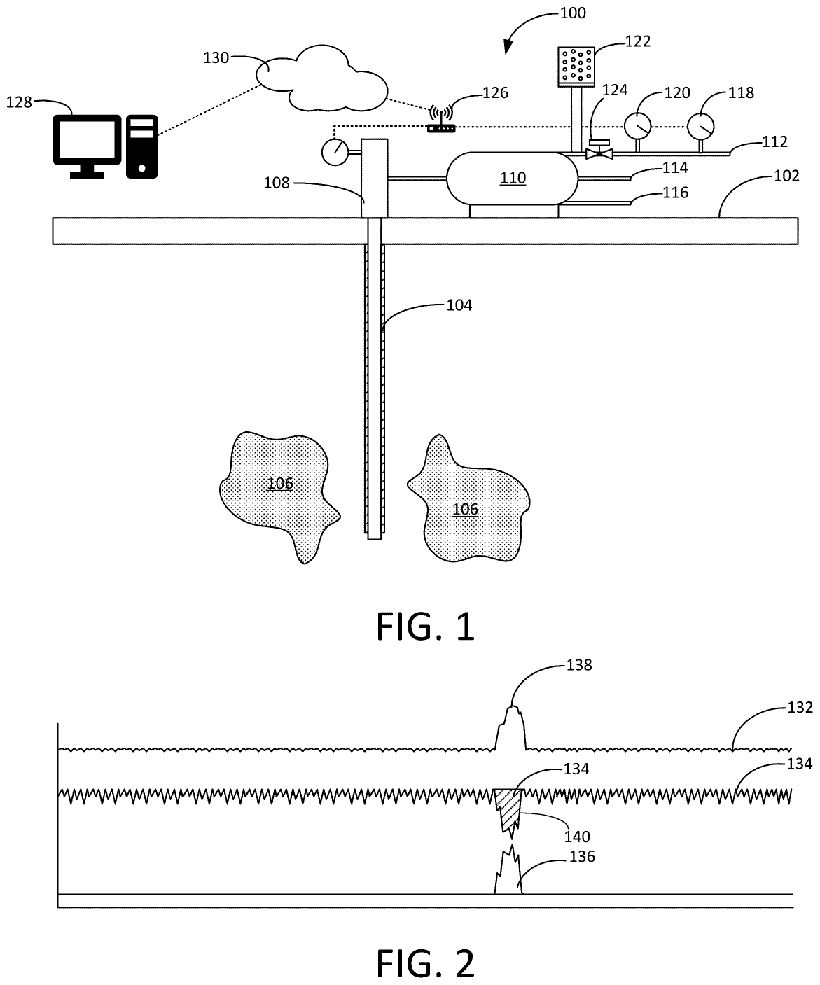

Turning to FIG. 1, shown therein is a wellsite 100 that includes a well pad 102 and a well 104. The well 104 is drilled for the production of petroleum products from a producing formation 106. The well 104 includes a wellhead 108 on the well pad 102, which may include one or more wells 104. It will be appreciated that the well pad 102 may be located onshore or offshore.

The wellsite 100 includes a phase separator 110 connected to the wellhead 108. The phase separator 110 is generally configured to separate gas, crude oil and water-based liquids produced from the well 104. The separated gas can be sent to a gas sales line 112, the separated oil can be sent to an oil sales line 114, and the separated water-based fluids can be directed to a water disposal line 116. It will be appreciated that the wellsite 100 depicted in FIG. 1 is merely exemplary and the wellsite 100 may include additional or alternative equipment, including tank batteries, pumps, compressors and flowback equipment.

The wellsite 100 includes a static pressure gauge 118 that is configured to measure and report the static pressure of the downstream gathering system connected to the well 104. The static pressure gauge 118 can be connected to the gas sales line 112 or in another location where the static pressure of the gathering system can be accurately evaluated. The wellsite 100 also includes a gas sales line flowmeter 120 that is connected to the gas sales line 112 and configured to measure and report the volume of gas delivered along the gas sales line 112.

The wellsite 100 includes a flare 122 that is connected to the gas sales line 112 and configured to combust natural gas. A flare control valve 124 is configured to automatically divert the flow of natural gas from the gas sales line 112 to the flare 122 when a triggering event occurs. For example, if the static pressure increases beyond a threshold extent, the flare control valve 124 can be configured to automatically divert to the flare 122 some or all of the natural gas that would otherwise be delivered to the sales line 112.

The operation of the wellsite 100 can be automated and controlled with a control system 126, which can be configured to adjust the operation of the components at the wellsite 100 and report the current operational conditions and measurements to an offsite supervisory system 128 through a data network 130. It will be appreciated that the control system 126 can be located at the wellsite 100, in a remote location, or in both local and remote locations with an interconnecting data network.

Turning now to FIG. 2, shown therein are graphs depicting the midstream static pressure over time 132 (pressure/time units), the gas sales rate over time 134 (volume/time units) and the estimated flare volume over time 136 (volume/time units). Using the midstream static pressure 132 and the gas sales rate 134, the estimated flare volume 136 can be determined according to the following method.

During normal operating conditions, the gas produced from the well 104 is delivered through the sales line 112, with no gas diverted to the flare 122. However, a high static pressure situation may periodically occur (as illustrated at interval 138) due to changes in the production of petroleum products from the well 104, downstream obstructions, changes in the gathering system, or other production and gathering anomalies. When the high static pressure event 138 occurs, it is measured and reported by the static pressure gauge 118. At the same time, the gas sales line flowmeter 120 may detect and report a decline in the gas sales rate 134 for the duration of the high static pressure event 138, which results in a determinable lost gas sales volume 140.

The lost gas sales volume 140 can be determined by finding the area under the gas sales rate 134 graph during the interval of the high static pressure event 138, i.e., the area represented by the instantaneous difference between the actual and baseline gas sales rates 134 across the duration of the high static pressure event 138. The determination of the lost gas sales volume 140 can be made, for example, by integrating the gas sale rate 134 curves (or graphs) across the duration of the high static pressure event 138. A number of commercially available computer programs are capable of automatically determining the lost gas sales volume 140 based on the decrease in the baseline gas sales rates 134 during the high static pressure event 138.

In some embodiments, it may be useful to calculate the lost gas sales volume 140 until the gas sales rate 134 returns to an expected value, which may occur later than the conclusion of the high static pressure event 138. In these embodiments, the lost gas sales volume 140 is determined by calculating the volume of gas that would have been expected to pass through the gas sales line flowmeter 120 during the period of time beginning with the onset of the high static pressure event 138 and ending with the return of the gas sales rate 134 to an expected value, for example, the baseline gas sales rate 134.

The control system 126 can be configured to automatically calculate one or more estimates for the lost gas sales volume 140 using the methods outlined above. The lost gas sales volume 140 can then be used and reported to the supervisory system 128 as the estimated flare volume 136. This method of determining an estimated flare volume 136 provides a quick and efficient method of determining flare volumes without relying on gas-to-oil ratios, which may be inaccurate and difficult to quantify in real time.

In some embodiments, the step of determining the estimated flare volume as a function of the lost gas sales volume includes applying a correction factor to the lost gas sales volume. The correction factor can be determined based one or more measurements from the wellsite 100, including as a function of the pressure reported by the static pressure gauge during the high static pressure event and the ratio of the baseline gas sales rate 134 to the actual gas sales rate 134 during the high static pressure event.

Thus, the methods disclosed herein provide a computer-implemented method for calculating an estimated flare volume of natural gas produced from a well connected to a gathering system through a gas sales line. The method includes the steps of determining a baseline static pressure for the gathering system with a static pressure gauge, reporting the static pressure to a computerized control system, determining a baseline gas sales rate with a gas sales line flowmeter, and reporting the baseline gas sales rate to the computerized control system. The method continues with the steps of identifying a high static pressure event with the static pressure gauge, reporting the high static pressure event to the computerized control system, identifying a decline in the gas sales rate that correlates to the onset of the high static pressure event, and reporting the decline in the gas sales rate to the computerized control system. Next, the method includes the steps of identifying the conclusion of the high static pressure event with the static pressure gauge and reporting the conclusion of the high static pressure event to the computerized control system. The method concludes with the steps of determining the lost gas sales volume as a function of the difference between the actual gas sales rate and the baseline gas sales rate beginning with the onset of the high static pressure event and determining the estimated flare volume as the lost gas sales volume. The estimated flare volume can be output as a report that can be displayed on a video monitor, printed, or otherwise provided directly as an input to a computerized process control system configured to monitor or adjust operations at the wellsite 100.

It is to be understood that even though numerous characteristics and advantages of various embodiments of the present invention have been set forth in the foregoing description, together with details of the structure and functions of various embodiments of the invention, this disclosure is illustrative only, and changes may be made in detail, especially in matters of structure and arrangement of parts and steps within the principles of the present invention to the full extent indicated by the broad general meaning of the terms in which the embodiments are expressed. It will be appreciated by those skilled in the art that the teachings of the present invention can be applied to other systems without departing from the scope and spirit of the present invention.

It is claimed:

1. A computer-implemented method for calculating an estimated flare volume of natural gas produced from a well connected to a gathering system through a gas sales line, the method comprising the steps of:
determining a baseline static pressure for the gathering system with a static pressure gauge;
reporting the baseline static pressure to a computerized control system;
determining a baseline gas sales rate with a gas sales line flowmeter;
reporting the baseline gas sales rate to the computerized control system;
identifying an onset of a high static pressure event with the static pressure gauge;
reporting the high static pressure event to the computerized control system;
identifying a decline in the gas sales rate that correlates to the onset of the high static pressure event;
reporting the decline in the gas sales rate to the computerized control system;
identifying a conclusion of the high static pressure event with the static pressure gauge;
reporting the conclusion of the high static pressure event to the computerized control system;
determining the lost gas sales volume as a function of the difference between the actual gas sales rate during the high static pressure event and the baseline gas sales rate;
determining the estimated flare volume as the lost gas sales volume; and
outputting the estimated flare volume.

2. A computer-implemented method for calculating an estimated flare volume of natural gas produced from a well connected to a gathering system through a gas sales line, the method comprising the steps of:
determining a baseline static pressure for the gathering system with a static pressure gauge;
determining a baseline gas sales rate with a gas sales line flowmeter;
identifying a high static pressure event with the static pressure gauge;
determining a lost gas sales volume during the high static pressure event; and
determining the estimated flare volume as a function of the lost gas sales volume.

3. The computer-implemented method of claim 2, further comprising the step of automatically diverting natural gas to a flare after the step of identifying the high static pressure event with the static pressure gauge.

4. The computer-implemented method of claim 3, where the step of determining the lost gas sales volume during the high static pressure event comprises:
calculating an actual gas sales rate during the high static pressure event; and
finding the difference between the actual gas sales rate and the baseline gas sales rate; and
determining the lost gas sales volume as the product of the difference between the baseline gas sales rate and the actual gas sales rate and a duration of time for the high static pressure event.

5. The computer-implemented method of claim 4, wherein the duration of time for the high static pressure event is determined as the time between an onset of the high static pressure event and a conclusion of the high static pressure event.

6. The computer-implemented method of claim 5, wherein the conclusion of high static pressure event is identified when the static pressure gauge reports a pressure that matches the baseline static pressure for the gathering system.

7. The computer-implemented method of claim 2, wherein the step of determining the estimated flare volume as a function of the lost gas sales volume comprises equating the estimated flare volume as the lost gas sales volume.

8. The computer-implemented method of claim 2, wherein the step of determining the estimated flare volume as a function of the lost gas sales volume comprises applying a correction factor to the lost gas sales volume to determine the estimated flare volume.

9. The computer-implemented method of claim 8, wherein the correction factor is determined as a function of the pressure reported by the static pressure gauge during the high static pressure event.

10. The computer-implemented method of claim 8, wherein the correction factor is determined as a function of atmospheric pressure and the pressure reported by the static pressure gauge during the high static pressure event.

11. The computer-implemented method of claim 2, further comprising a step of reporting the static pressure to a computerized control system.

12. The computer-implemented method of claim 11, further comprising a step of reporting the baseline gas sales rate to the computerized control system.

13. The computer-implemented method of claim 12, further comprising a step of reporting the high static pressure event to the computerized control system.

14. The computer-implemented method of claim 13, further comprising a step of reporting the decline in the gas sales rate to the computerized control system.

15. The computer-implemented method of claim 14, further comprising a step of identifying the conclusion of the high static pressure event with the static pressure gauge.

16. The computer-implemented method of claim 15, further comprising a step of reporting the conclusion of the high static pressure event to the computerized control system.

17. A computer-implemented method for calculating an estimated flare volume of natural gas produced from a well connected to a gathering system through a gas sales line, the method comprising the steps of:
determining a baseline static pressure for the gathering system with a static pressure gauge;
determining a baseline gas sales rate with a gas sales line flowmeter;
identifying an onset of a high static pressure event with the static pressure gauge;
automatically diverting natural gas to a flare;
identifying a conclusion of the high static pressure event with the static pressure gauge;
automatically diverting natural gas from the flare to the gas sales line;
determining a lost gas sales volume during the high static pressure event; and
determining the estimated flare volume as a function of the lost gas sales volume.

18. The computer-implemented method of claim 17, where the step of determining the lost gas sales volume during the high static pressure event comprises:
calculating an actual gas sales rate during the high static pressure event; and
finding the difference between the baseline gas sales rate and the actual gas sales rate during the high static pressure event; and
determining the lost gas sales volume as the product of the difference between the baseline gas sales rate and the actual gas sales rate and a duration of time for the high static pressure event.

19. The computer-implemented method of claim 18, wherein the duration of time for the high static pressure event is determined as the time between the onset of the high static pressure event and the conclusion of the high static pressure event.

20. The computer-implemented method of claim 19, wherein the conclusion of high static pressure event is identified when the static pressure gauge reports a pressure that matches the baseline static pressure for the gathering system.
